(19) United States
(12) Patent Application Publication
(10) Pub. No.: US 2019/0092276 A1
(43) Pub. Date: Mar. 28, 2019

(54) WEBBING TAKE-UP DEVICE

(71) Applicant: KABUSHIKI KAISHA TOKAI-RIKA-DENKI-SEISAKUSHO, Aichi (JP)

(72) Inventors: Hitoshi TAKAMATSU, Aichi (JP); Akira SUMIYASHIKI, Aichi (JP)

(21) Appl. No.: 16/086,156

(22) PCT Filed: Feb. 27, 2017
(86) PCT No.: PCT/JP2017/007474

§ 371 Date: Sep. 18, 2018

(30) Foreign Application Priority Data
Mar. 29, 2016 (JP) 2016-066067

(51) Int. Cl. B60R 22/405; B60R 22/46

(52) U.S. Cl. CPC B60R 22/405; B60R 22/4676

(57) ABSTRACT

In a webbing take-up device, when a pre-tensioner is actuated and a spool then rotates in a pull-out direction in a state in which an engagement tooth of a restricting pawl has meshed with external teeth of a gear plate, the restricting pawl swings together with the gear plate. This suppresses release of the meshing between the engagement tooth of the restricting pawl and the external teeth of the gear plate. This thereby enables inertial force of a flywheel to be transmitted to the spool, irrespective of the rotational acceleration of the flywheel or the magnitude of a rotation speed of the flywheel.

### TECHNICAL FIELD

The present invention relates to a webbing take-up device capable of absorbing some rotational force in a spool pull-out direction.

### BACKGROUND ART

Webbing take-up devices exist in which, in a vehicle emergency, when an inertial body is in an actuated state when a spool rotates in a pull-out direction, inertia of the inertial body resists pull-out direction rotation of the spool, thereby absorbing some rotational force in the pull-out direction of the spool (see, for example, Japanese National-Phase Publication No. 2003-512233).

Such webbing take-up devices include a pre-tensioner. The pre-tensioner actuates in a vehicle emergency. On actuation of the pre-tensioner, the spool is rotated in a take-up direction, taking up a webbing onto the spool. The body of an occupant is thereby restrained by the webbing.

In webbing take-up devices including such a pre-tensioner and an inertial body, providing a one-way clutch between the spool and the inertial body may be considered as one way of preventing the inertial body from rotating in the take-up direction together with the spool when the spool is rotated in the take-up direction on actuation of the pre-tensioner.

However, such a configuration would not allow rotational force of the inertial body rotating under inertia to be imparted to the spool as a rotational force in the spool pull-out direction.

### SUMMARY OF INVENTION

### Technical Problem

In consideration of the above circumstances, an object of the present invention is to obtain a webbing take-up device in which, following actuation of a pre-tensioner, rotational force of an inertial body rotating under inertia can be imparted to a spool as a rotational force in a spool pull-out direction.

### Solution to Problem

A webbing take-up device of a first aspect of the present disclosure includes a spool, a pre-tensioner, an inertial body, and a clutch mechanism. The spool is rotated in a take-up direction to take up a webbing. The pre-tensioner is actuated in a vehicle emergency to rotate the spool in the take-up direction. Rotation of the spool is transmitted to the inertial body so as to impart an inertial force to the spool according to a rotational acceleration of the spool or according to a magnitude of a rotation speed of the spool. The clutch mechanism suppresses transmission of take-up direction rotation from the spool to the inertial body, and transmits inertial force of the inertial body in the take-up direction or in a pull-out direction of the spool to the spool when the spool rotates in the pull-out direction following actuation of the pre-tensioner.

In the webbing take-up device of the first aspect of the present disclosure, the clutch mechanism suppresses transmission of take-up direction rotation from the spool to the inertial body. Moreover, the clutch mechanism actuates when the spool rotates in the pull-out direction following actuation of the pre-tensioner. As a result of actuation of the clutch mechanism, inertial force of the inertial body in the take-up direction or in the pull-out direction of the spool is transmitted to the spool. Accordingly, when the spool is rotated in the take-up direction by the pre-tensioner, and the spool then rotates in the pull-out direction, rotation force of the inertial body that rotates under inertia following actuation of the pre-tensioner can be imparted to the spool as rotational force in the pull-out direction of the spool.

A webbing take-up device of a second aspect of the present disclosure is the webbing take-up device of the first aspect, wherein the clutch mechanism includes a moving member and a restricting member. The moving member is moved by rotation of the spool such that rotation is suppressed from being transmitted from the spool to the inertial body, and by being restricted from moving results in rotation from the spool being transmitted to the inertial body. The restricting member is capable of engaging with the moving member, and restricts movement of the moving member by engaging with the moving member when the spool rotates in the pull-out direction following actuation of the pre-tensioner.

In the webbing take-up device of the second aspect of the present disclosure, when the moving member is moved by rotation of the spool, the rotation of the spool is suppressed from being transmitted to the inertial body. When the spool rotates in the pull-out direction following actuation of the pre-tensioner and the restricting member engages with the moving member, movement of the moving member is restricted by the restricting member. Accordingly, when the spool is rotated in the take-up direction by the pre-tensioner, and the spool then rotates in the pull-out direction, rotational force of the inertial body rotating under inertia following actuation of the pre-tensioner can be imparted to the spool as rotational force in the pull-out direction rotation of the spool.

A webbing take-up device of a third aspect of the present disclosure is the webbing take-up device of the second aspect, wherein the restricting member enables the moving member to be moved by take-up direction rotation of the spool in a state in which the restricting member is engaged with the moving member, and restricts the moving member from being moved by both pull-out direction rotation of the spool and take-up direction rotation of the spool when, in a state in which the restricting member is engaged with the moving member, the restricting member has been moved together with the moving member by a predetermined amount as a result of pull-out direction rotation of the spool.

In the webbing take-up device of the third aspect of the present disclosure, the restricting member of the clutch mechanism is capable of engaging with the moving member accompanying actuation of the pre-tensioner. In an engaged state of the restricting member with the moving member, the moving member is permitted to move when the spool rotates in the take-up direction. Accordingly, in this state, even if the spool rotates in the take-up direction in an actuated state of the pre-tensioner, take-up direction rotation of the spool can be suppressed from being transmitted to the inertial body.

In the engaged state of the restricting member with the moving member, when the moving member moves as a result of pull-out direction rotation of the spool, the restricting member moves by a predetermined amount together with the moving member. Movement of the moving member is thereby restricted by the restricting member for both pull-out direction rotation of the spool and take-up direction rotation of the spool, such that rotation of the spool is transmitted to the inertial body. Accordingly, when the spool is rotated in the take-up direction by the pre-tensioner and the spool then rotates in the pull-out direction, inertial force of the inertial body can be imparted to the spool in response to pull-out direction rotation of the spool.

A webbing take-up device of a fourth aspect of the present disclosure is the webbing take-up device of the third aspect, further including a retention member that is moved by the restricting member being moved together with the moving member by a predetermined amount as a result of pull-out direction rotation of the spool in a state in which the restricting member is engaged with the moving member, and that engages with the restricting member so as to retain the engagement between the restricting member and the moving member.

In the webbing take-up device of the fourth aspect of the present disclosure, the retention member is moved by the restricting member being moved together with the moving member by a predetermined amount as a result of pull-out direction rotation of the spool in a state in which the restricting member is engaged with the moving member. The engagement between the restricting member and the moving member is retained as a result of the retention member engaging with the restricting member, enabling rotation transmission between the spool and the inertial body to be maintained.

A webbing take-up device of a fifth aspect of the present disclosure is the webbing take-up device of the second aspect, further including a blocking member that blocks engagement of the restricting member with the moving member, and that releases the blocking of engagement of the restricting member with the moving member accompanying pull-out direction rotation of the spool.

In the webbing take-up device of the fifth aspect of the present disclosure, the restricting member of the clutch mechanism is blocked from engaging with the moving member by the blocking member. The blocking of engagement of the restricting member with the moving member by the blocking member is released accompanying take-up direction rotation of the spool. Accordingly, when the pre-tensioner actuates, a trigger section is actuated and the spool is rotated in the take-up direction accompanying actuation of the pre-tensioner, enabling the restricting member to engage with the moving member. Accordingly, when the spool is rotated in the take-up direction by the pre-tensioner, and the spool then rotates in the pull-out direction, rotation can be transmitted between the spool and the inertial body irrespective of the rotation speed of the inertial body, enabling inertial force of the inertial body to be imparted to the spool in response to pull-out direction rotation of the spool.

A webbing take-up device of a sixth aspect of the present disclosure is the webbing take-up device of any one of the first aspect to the fifth aspect, further including a trigger section that retains the clutch mechanism in a state in which take-up direction rotation is suppressed from being transmitted from the spool to the inertial body, and that releases the retention of the clutch mechanism when actuated mechanically in coordination with actuation of the pre-tensioner.

In the webbing take-up device of the sixth aspect of the present disclosure, the clutch mechanism is retained by the trigger section in a state in which take-up direction rotation is suppressed from being transmitted from the spool to the inertial body. On actuation of the pre-tensioner, the trigger section is actuated mechanically in coordination with the actuation of the pre-tensioner, thereby releasing the retention of the clutch mechanism by the trigger section. This thereby enables the clutch mechanism to be mechanically coordinated with actuation of the pre-tensioner.

As described above, the webbing take-up device according to the present invention enables rotational force of the inertial body rotating under inertia following actuation of the pre-tensioner to be imparted to the spool as a rotational force in the pull-out direction of the spool.

### BRIEF DESCRIPTION OF DRAWINGS

FIG. 1 is a face-on view illustrating a webbing take-up device according to a first exemplary embodiment.

FIG. 2 is an enlarged side view illustrating a pre-tensioner and a trigger device of the webbing take-up device according to the first exemplary embodiment, as viewed from a vehicle rear side at the position of line 2-2.

FIG. 3 is an enlarged side view illustrating a rotation transmission mechanism and a trigger device of the webbing take-up device according to the first exemplary embodiment, as viewed from a vehicle front side at the position of line 3-3.

FIG. 4 is a side view corresponding to FIG. 3, illustrating a state in which an engagement tooth of a restricting pawl is meshed with external teeth of a gear plate.

FIG. 5 is a side view corresponding to FIG. 4, illustrating a state in which the restricting pawl has moved toward a pull-out direction side together with the gear plate in a state in which the engagement tooth of the restricting pawl is meshed with external teeth of the gear plate.

FIG. 6 is an enlarged side view corresponding to FIG. 3, illustrating a rotation transmission mechanism and a trigger device of a webbing take-up device according to a second exemplary embodiment.

FIG. 7 is a side view corresponding to FIG. 6, illustrating a state in which an engagement tooth of a restricting pawl is meshed with external teeth of a gear plate.

FIG. 8 is a side view corresponding to FIG. 7, illustrating a state in which the restricting pawl has moved toward a pull-out direction side together with the gear plate in a state in which the engagement tooth of the restricting pawl is meshed with external teeth of the gear plate.

FIG. 9 is an enlarged side view corresponding to FIG. 3, illustrating a rotation transmission mechanism and a trigger device of a webbing take-up device according to a third exemplary embodiment.

FIG. 10 is a side view corresponding to FIG. 9, illustrating a state in which an engagement tooth of a restricting pawl is meshed with external teeth of a gear plate.

FIG. 11 is a side view corresponding to FIG. 10, illustrating a state in which the restricting pawl has moved toward a pull-out direction side together with the gear plate in a state in which the engagement tooth of the restricting pawl is meshed with external teeth of the gear plate.

FIG. 12 is an enlarged side view illustrating a rotation transmission mechanism, a trigger device, and a stopper plate of a webbing take-up device according to a fourth exemplary embodiment, as viewed from a vehicle front side.

FIG. 13 is a side view corresponding to FIG. 12, illustrating a state in which engagement teeth of a slider have meshed with external teeth of a gear plate.

FIG. 14 is a side view corresponding to FIG. 13, illustrating a state in which the stopper plate has swung in a take-up direction together with a support member in a state in which the engagement teeth of the slider have meshed with the external teeth of the gear plate.

### DESCRIPTION OF EMBODIMENTS

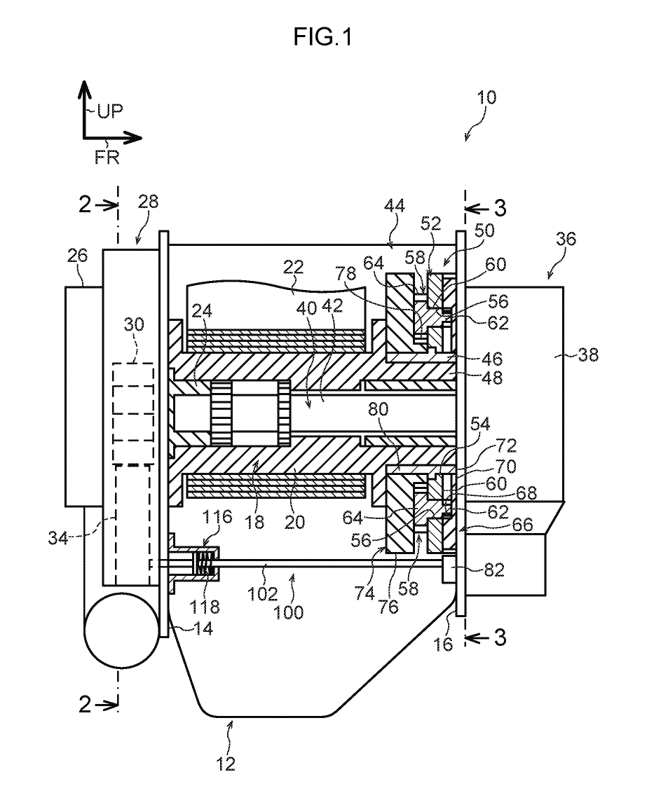

Explanation follows regarding exemplary embodiments of the present invention, with reference to FIG. 1 to FIG. 14. In the drawings, the arrow FR indicates a front side of a vehicle applied with a webbing take-up device 10. The arrow OUT indicates the vehicle width direction outside. The arrow UP indicates the vehicle upper side. In later embodiments, locations that are basically the same as those already covered in an earlier exemplary embodiment will be allocated the same reference numerals, and detailed explanation thereof will be omitted.

### First Exemplary Embodiment: Configuration

As illustrated in FIG. 1, the webbing take-up device 10 according to the first exemplary embodiment includes a frame 12. The frame 12 is fixed to a vehicle lower side portion of a center pillar (not illustrated in the drawings), serving as a vehicle body of the vehicle. The frame 12 includes leg plates 14, 16. The leg plate 14 and the leg plate 16 face each other substantially along a vehicle front-rear direction.

The webbing take-up device 10 also includes a spool 18. The spool 18 includes a spool body 20. The spool body 20 is formed in a substantially circular cylinder shape, and is disposed between the leg plate 14 and the leg plate 16 of the frame 12. The axial center of the spool body 20 runs along the direction in which the leg plate 14 and the leg plate 16 face each other (namely, substantially along the vehicle front-rear direction), and the spool body 20 is capable of rotating about the axial center.

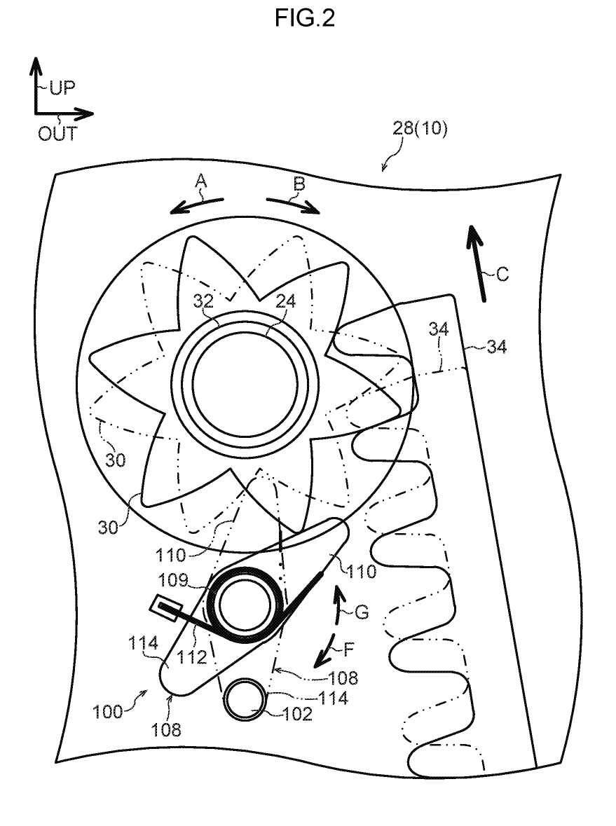

A length direction base end portion of an elongated belt-shaped webbing 22 is anchored to the spool body 20 of the spool 18. When the spool body 20 is rotated in a take-up direction (the arrow A direction in FIG. 2 etc.), the webbing 22 is taken up onto the spool body 20 of the spool 18 from a length direction base end side. A length direction leading end side of the webbing 22 extends from the spool body 20 of the spool 18 toward the vehicle upper side. The length direction leading end side of the webbing 22 passes through a slit formed in a through anchor (not shown in the drawings) supported by the center pillar at the vehicle upper side of the frame 12, and folds back toward the vehicle lower side.

A length direction leading end portion of the webbing 22 is anchored to an anchor plate (not shown in the drawings). The anchor plate is formed from a metal plate material such as steel, and is fixed to the vehicle floor (not shown in the drawings), or fixed to a framework member or the like of a seat (not shown in the drawings) corresponding to the webbing take-up device 10.

A vehicle seatbelt device applied with the webbing take-up device 10 includes a buckle device (not shown in the drawings). The buckle device is provided at the vehicle width direction inside of the seat to which the webbing take-up device 10 is applied. A tongue (not shown in the drawings) provided to the webbing 22 is engaged with the buckle device in a state in which the webbing 22 has been wrapped across the body of an occupant sitting in the seat, such that the webbing 22 is fitted over the body of the occupant.

The spool body 20 of the spool 18 is provided with an adaptor 24. A portion of the adaptor 24 further toward the vehicle front side than a vehicle front-rear direction intermediate portion of the adaptor 24 is inserted into the spool body 20 of the spool 18 from the vehicle rear side of the spool body 20. Rotation of the adaptor 24 relative to the spool body 20 of the spool 18 is restricted. A portion of the adaptor 24 further toward the vehicle rear side than the vehicle front-rear direction intermediate portion of the adaptor 24 extends through a hole formed in the leg plate 14 of the frame 12 toward the outside of the frame 12 (toward the vehicle rear side).

A spring housing 26 is provided at the vehicle rear side of the leg plate 14 of the frame 12. A spool urging section such as a spiral spring (not shown in the drawings) is provided inside the spring housing 26. The spool urging section is directly or indirectly engaged with the adaptor 24, and the spool body 20 of the spool 18 is urged in the take-up direction (the arrow A direction in FIG. 2 etc.) through the adaptor 24 by urging force of the spool urging section.

Moreover, a pre-tensioner 28 is provided between the leg plate 14 of the frame 12 and the spring housing 26. A vehicle rear side portion of the adaptor 24 is disposed inside the pre-tensioner 28. The pre-tensioner 28 is provided with a pinion 30, serving as a rotation member. The pinion 30 is disposed coaxially with the vehicle rear side portion of the adaptor 24. A clutch 32 is provided between the pinion 30 of the pre-tensioner 28 and the vehicle rear side portion of the adaptor 24. In a state prior to actuation of the clutch 32, transmission of rotation between the adaptor 24 and the pinion 30 is blocked. When the pinion 30 rotates in the take-up direction (the arrow A direction in FIG. 2) in this state, the clutch 32 actuates, forming an integral mechanical link between the pinion 30 and the adaptor 24 through the clutch 32. Rotation is thus transmitted from one to the other between the pinion 30 and the adaptor 24.

The pre-tensioner 28 further includes a rack bar 34. The rack bar 34 is capable of meshing with the pinion 30 of the pre-tensioner 28. When the pre-tensioner 28 actuates in a vehicle emergency, the rack bar 34 is moved obliquely toward the vehicle upper side (in the arrow C direction in FIG. 2). When the rack bar 34 is moved obliquely toward the vehicle upper side (the arrow C direction in FIG. 2), the rack bar 34 meshes with the pinion 30, thereby rotating the pinion 30 in the take-up direction (the arrow A direction in FIG. 2).

A lock housing 38 of a lock mechanism 36 is provided at the vehicle front side of the leg plate 16 of the frame 12. A rotating lock body (not illustrated in the drawings) is provided inside the lock housing 38. The rotating lock body is provided capable of rotating about the axial center of the spool body 20 of the spool 18. A lock member (not illustrated in the drawings) is also provided inside the lock housing 38. The lock mechanism 36 actuates in a vehicle emergency, such as a vehicle collision. When the lock mechanism 36 is actuated, the lock member restricts rotation of the rotating lock body in a pull-out direction (the arrow B direction in FIG. 2 etc.).

The webbing take-up device 10 further includes a first force limiter mechanism 40 (the first force limiter mechanism 40 is referred to hereafter as the “first FL mechanism 40”), configuring a force limiter. The first FL mechanism 40 includes a torsion bar 42. The torsion bar 42 is formed in an elongated rod shape extending substantially in the vehicle front-rear direction. A vehicle rear side portion of the torsion bar 42 is disposed inside the spool body 20 of the spool 18, and is connected to the spool body 20 in a state in which rotation of the torsion bar 42 relative to the spool body 20 is prevented.

A vehicle front side portion of the torsion bar 42 extends through a hole formed in the leg plate 16 of the frame 12 toward the outside (vehicle front side) of the frame 12, and enters the lock housing 38 of the lock mechanism 36. The vehicle front side portion of the torsion bar 42 that is inside the lock housing 38 of the lock mechanism 36 is engaged with the rotating lock body of the lock mechanism 36. The rotating lock body of the lock mechanism 36 is restricted from rotating relative to the torsion bar 42 is restricted.

The rotating lock body of the lock mechanism 36 is thus connected to the spool body 20 of the spool 18 through the torsion bar 42, and rotation of the rotating lock body of the lock mechanism 36 relative to the spool body 20 is restricted. Accordingly, when the lock mechanism 36 actuates and pull-out direction (arrow B direction in FIG. 2 etc.) rotation of the rotating lock body is restricted by the lock member, pull-out direction rotation of the spool body 20 of the spool 18 is indirectly restricted. The webbing 22 is thus restricted from being pulled out from the spool body 20 of the spool 18.

A second force limiter mechanism 44 (the second force limiter mechanism 44 is referred to hereafter as the “second FL mechanism 44”), serving as an inertia-resisting portion and configuring a force limiter, is provided between the spool body 20 of the spool 18 and the leg plate 16 of the frame 12. As illustrated in FIG. 2, the second FL mechanism 44 includes a support member 46. The support member 46 is formed in a tube shape. An external peripheral profile of the support member 46 is circular, and an internal peripheral profile of the support member 46 is non-circular, for example a polygonal shape (hexagonal, in the present exemplary embodiment), or spline-shaped.

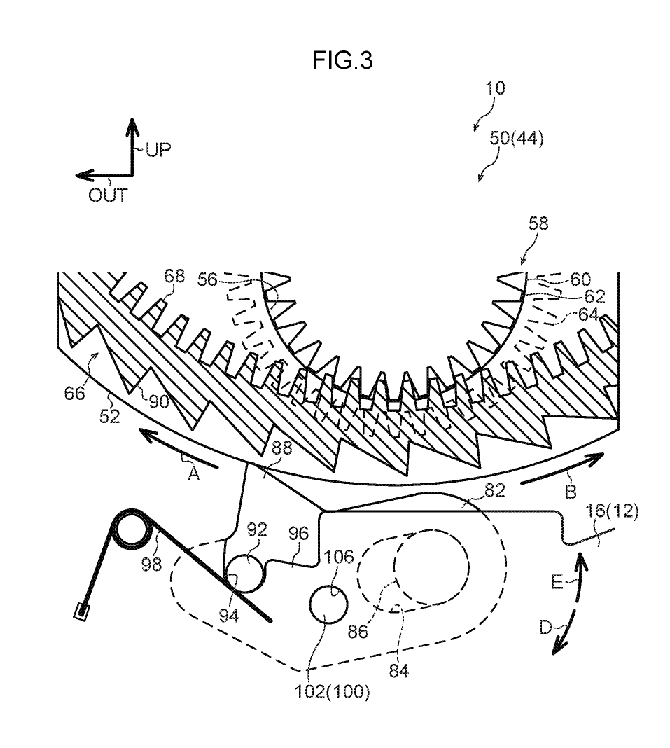

As illustrated in FIG. 3, an attachment portion 48 of the spool 18 is inserted inside the support member 46 of the second FL mechanism 44. The attachment portion 48 of the spool 18 is provided at the vehicle front side of the spool body 20 of the spool 18, and the attachment portion 48 is integrally formed to the spool body 20 so as to be coaxial with the spool body 20. A cross-section profile of the attachment portion 48 of the spool 18 has the same shape as the internal profile of the support member 46 of the second FL mechanism 44, such that rotation of the support member 46 relative to the spool 18 is restricted.

As illustrated in FIG. 1, the second FL mechanism 44 includes a rotation force transmission mechanism 50, serving as a clutch mechanism configuring a rotation transmission section that serves as a speed booster, this being one type of speed changer. The rotation force transmission mechanism 50 includes a carrier plate 52 configuring an input member, and serving as a first rotating body. The carrier plate 52 is configured in a substantially circular plate shape, and a through hole 54 is formed through the approximate center of the carrier plate 52. The support member 46 of the second FL mechanism 44 is disposed passing through the through hole 54 in the carrier plate 52. The portion of the support member 46 disposed inside the through hole 54 in the carrier plate 52 is formed with an anti-spin portion, such that when the support member 46 is disposed passing through the through hole 54 in the carrier plate 52, the anti-spin portion of the support member 46 engages with the carrier plate 52, thereby restricting rotation of the carrier plate 52 relative to the support member 46.

The carrier plate 52 of the rotation force transmission mechanism 50 (second FL mechanism 44) is formed with a pair of support holes 56. The support holes 56 pass through the carrier plate 52. The support holes 56 are formed such that one and the other of the support holes 56 are on the opposite sides of the through hole 54 in the carrier plate 52 to each other. The support holes 56 have circular internal peripheral profiles, and a distance from the center of the through hole 54 in the carrier plate 52 to the center of one support hole 56 is the same as the distance from the center of the through hole 54 in the carrier plate 52 to the center of the other support hole 56.

A planetary gear 58 configuring an intermediate member, serving as a second rotating body, is provided in each support hole 56 in the carrier plate 52 of the rotation force transmission mechanism 50 (second FL mechanism 44). Each of the planetary gears 58 of the rotation force transmission mechanism 50 (second FL mechanism 44) includes a shaft 60. The shaft 60 of each planetary gear 58 has a circular column shape. The shafts 60 of the planetary gears 58 are disposed in the support holes 56 in the carrier plate 52. The planetary gears 58 are thus supported by the carrier plate 52 so as to be capable of rotating about their respective shafts 60.

A first gear 62 is provided at the vehicle front side of the shaft 60 of each planetary gear 58 of the rotation force transmission mechanism 50 (second FL mechanism 44), and a second gear 64 is provided at the vehicle rear side of the shaft 60 of each planetary gear 58. The first gear 62 and the second gear 64 of each planetary gear 58 are externally-toothed spur gears, and the circle described by leading ends of the teeth of the first gear 62 is smaller than the external profile of the shaft 60 of the planetary gear 58. The circle described by leading ends of the teeth of the second gear 64 is larger than the external profile of the shaft 60 of the planetary gear 58. The number of teeth on the first gear 62 is lower than the number of teeth on the second gear 64.

The rotation force transmission mechanism 50 (second FL mechanism 44) also includes a gear plate 66. The gear plate 66 includes an internal-toothed gear 68. The internal-toothed gear 68 of the gear plate 66 is ring-shaped, and internal spur teeth are formed at an inner peripheral portion of the internal-toothed gear 68. The external teeth of the first gear 62 of each planetary gear 58 mesh together with the internal teeth of the internal-toothed gear 68 of the gear plate 66. A vehicle front side end of the internal-toothed gear 68 of the gear plate 66 is closed off by a plate 70.

A plate hole 72 is formed in the approximate center of the plate 70 of the gear plate 66 of the rotation force transmission mechanism 50 (second FL mechanism 44). The plate hole 72 of the gear plate 66 is substantially circular, and the support member 46 is disposed passing through the plate hole 72 of the gear plate 66. The gear plate 66 is thereby coaxial with the support member 46 and is capable of rotating relative to the support member 46.

The second FL mechanism 44 includes a flywheel 74 configuring a second load absorbing member, serving as an inertial body. The flywheel 74 includes a flywheel body 76. The flywheel body 76 is formed in a circular disc shape. A sun gear 78, configuring an output member serving as a third rotating body of the rotation force transmission mechanism 50 (second FL mechanism 44), is provided at the vehicle front side of the flywheel body 76. The sun gear 78 is an externally-toothed spur gear, and is integrally formed to the flywheel body 76 so as to be coaxial with the flywheel body 76.

A flywheel hole 80 is formed in the flywheel 74 (namely, the flywheel body 76 and the sun gear 78) of the second FL mechanism 44. The flywheel hole 80 is formed penetrating the flywheel 74 at the approximate center of the flywheel 74. The support member 46 is disposed passing through the flywheel hole 80 in the flywheel 74. The flywheel 74 is thus coaxial with the support member 46 and is capable of rotating relative to the support member 46.

The second gear 64 of each planetary gear 58 meshes with the sun gear 78 of the flywheel 74. Namely, the carrier plate 52, the planetary gears 58, the gear plate 66, and the flywheel 74 configure a planetary gear train. Note that the mass of the flywheel 74 is greater than the mass of the gear plate 66, and the rotational force required from the planetary gears 58 in order to rotate the flywheel 74 is greater than the rotational force required from the planetary gears 58 in order to rotate the gear plate 66.

Accordingly, rotation of the carrier plate 52 is transmitted to both the sun gear 78 of the flywheel 74 and the internal-toothed gear 68 of the gear plate 66 through the planetary gears 58. In a state in which rotation of the gear plate 66 is not being restricted, the gear plate 66 is rotated by the rotation of the carrier plate 52, whereas rotation of the flywheel 74 is suppressed. By contrast, in a state in which rotation of the gear plate 66 is being restricted, the flywheel 74 is rotated faster than the carrier plate 52 and in the same rotation direction as the carrier plate 52 by the rotation of the carrier plate 52.

As illustrated in FIG. 1 and FIG. 3, a restricting pawl 82, serving as a restricting member of the clutch mechanism, is provided at a vehicle lower side of the gear plate 66 of the rotation force transmission mechanism 50 (second FL mechanism 44). As illustrated in FIG. 3, the restricting pawl 82 is disposed at the vehicle rear side of the leg plate 16 of the frame 12. The restricting pawl 82 is formed in a plate shape, and a thickness direction of the restricting pawl 82 runs along the vehicle front-rear direction. The restricting pawl 82 is formed with an elongated hole 84. The elongated hole 84 penetrates the restricting pawl 82 in its thickness direction, and a pawl support shaft 86 provided at a vehicle rear side of the leg plate 16 of the frame 12 enters the elongated hole 84. The pawl support shaft 86 is either supported on the leg plate 16 of the frame 12, or is integral to the leg plate 16 of the frame 12. An axial direction of the pawl support shaft 86 runs in the vehicle front-rear direction, and the restricting pawl 82 is supported by the pawl support shaft 86 so as to be capable of swinging about the pawl support shaft 86, and is also capable of moving along the length direction of the elongated hole 84.

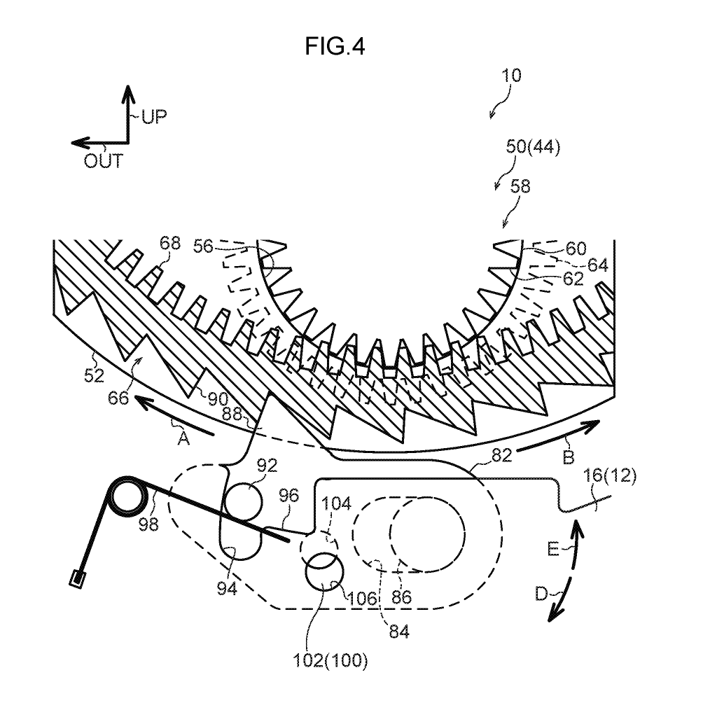

An engagement tooth 88 is formed at a leading end side portion of the restricting pawl 82. External teeth 90 are formed corresponding to the engagement tooth 88 of the restricting pawl 82 at an outer peripheral portion of the gear plate 66 of the rotation force transmission mechanism 50 (second FL mechanism 44). The external teeth 90 of the gear plate 66 have a ratchet-toothed profile, and when the restricting pawl 82 swings in an engagement direction (the arrow D direction in FIG. 3 etc.), this being one direction about the pawl support shaft 86, then as illustrated in FIG. 4, the engagement tooth 88 of the restricting pawl 82 is capable of meshing with the external teeth 90 of the gear plate 66.

The restricting pawl 82 is also formed with a locking pin 92. The locking pin 92 projects toward the vehicle front side from a leading end side portion of the restricting pawl 82. A corresponding guide hole 94 is formed in the leg plate 16 of the frame 12. The guide hole 94 penetrates the leg plate 16 of the frame 12. The guide hole 94 has an elongated profile, and a length direction of the guide hole 94 follows a circumferential direction centered on the pawl support shaft 86 of the leg plate 16 of the frame 12.

The position at which the locking pin 92 is formed to the restricting pawl 82 is set such that in a state in which a length direction base end of the elongated hole 84 in the restricting pawl 82 is abutted by the pawl support shaft 86 of the leg plate 16 of the frame 12 (the state illustrated in FIG. 3), the locking pin 92 of the restricting pawl 82 is capable of entering the guide hole 94 in the leg plate 16 of the frame 12. Accordingly, in a state in which the length direction base end of the elongated hole 84 in the restricting pawl 82 is abutted by the pawl support shaft 86 of the leg plate 16 of the frame 12, the restricting pawl 82 swings about the pawl support shaft 86 such that the locking pin 92 of the restricting pawl 82 moves along the length direction of the guide hole 94 in the leg plate 16 of the frame 12.

As illustrated in FIG. 4, in a state in which the length direction base end of the elongated hole 84 in the restricting pawl 82 is abutted by the pawl support shaft 86 of the leg plate 16 of the frame 12, the restricting pawl 82 swings about the pawl support shaft 86 in the engagement direction (the arrow D direction in FIG. 4), and in a state in which the engagement tooth 88 of the restricting pawl 82 has meshed with the external teeth 90 of the gear plate 66 of the rotation force transmission mechanism 50 (second FL mechanism 44), if the gear plate 66 attempts to rotate in the take-up direction (the arrow A direction in FIG. 4), the engagement tooth 88 of the restricting pawl 82 receives a pressing force from the external teeth 90 of the gear plate 66. The restricting pawl 82 accordingly swings in an engagement-release direction (the arrow E direction in FIG. 4), and the meshing of the engagement tooth 88 of the restricting pawl 82 with the external teeth 90 of the gear plate 66 is released, thus allowing the gear plate 66 to rotate in the take-up direction.

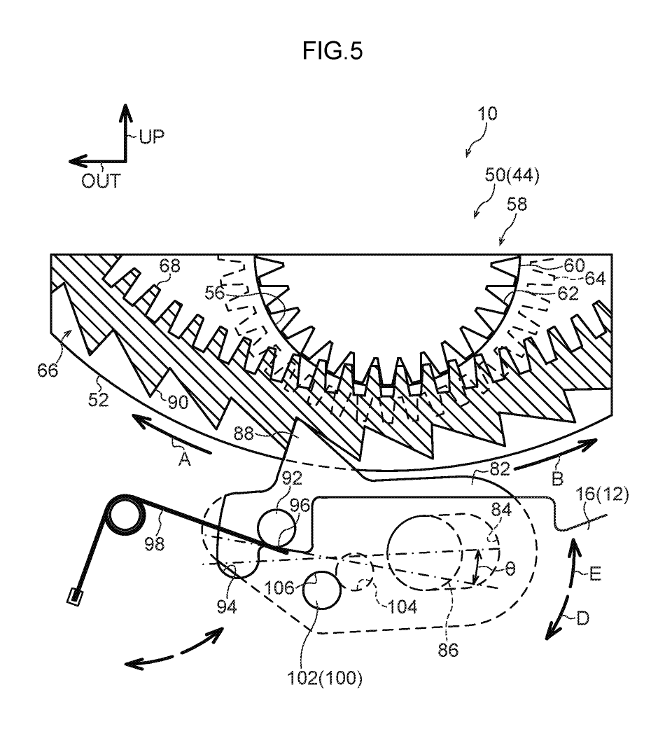

By contrast, in a state in which the engagement tooth 88 of the restricting pawl 82 is meshed with the external teeth 90 of the gear plate 66 of the rotation force transmission mechanism 50 (second FL mechanism 44) as described above, when the gear plate 66 is rotated in the pull-out direction (the arrow B direction in FIG. 4), the restricting pawl 82 swings about the pawl support shaft 86 in the engagement-release direction (the arrow E direction in FIG. 4) and moves in the length direction of the elongated hole 84, while the engagement tooth 88 of the restricting pawl 82 remains meshed with the external teeth 90 of the gear plate 66, until the length direction leading end of the elongated hole 84 in the restricting pawl 82 is abutted by the pawl support shaft 86 of the leg plate 16 of the frame 12 (see FIG. 5).

As illustrated in FIG. 5, a state in which the restricting pawl 82 moves and swings such that the length direction leading end of the elongated hole 84 in the restricting pawl 82 is abutted by the pawl support shaft 86 of the leg plate 16 of the frame 12 corresponds to a pawl-locked state. In the pawl-locked state, movement and swinging of the restricting pawl 82 when applied with pull-out direction (the arrow B direction in FIG. 5) rotational force of the gear plate 66 of the rotation force transmission mechanism 50 (second FL mechanism 44) is restricted, thereby restricting pull-out direction rotation of the gear plate 66.

The leg plate 16 of the frame 12 is also formed with a restriction portion 96. The restriction portion 96 configures a portion of the leg plate 16 of the frame 12 that is further toward the vehicle width direction inside than the guide hole 94. As illustrated in FIG. 5, a vehicle upper side end of the restriction portion 96 is positioned at the vehicle lower side of the locking pin 92 of the restricting pawl 82 in the pawl-locked state.

Accordingly, in this state, when the restricting pawl 82 attempts to swing in the engagement-release direction (the arrow E direction in FIG. 5) about the pawl support shaft 86, the locking pin 92 of the restricting pawl 82 is abutted by the vehicle upper side end of the restriction portion 96 of the leg plate 16 of the frame 12. Accordingly, in the pawl-locked state, swinging of the restricting pawl 82 in the engagement-release direction (the arrow E direction in FIG. 5) about the pawl support shaft 86 is restricted, thereby restricting release of the meshing of the engagement tooth 88 of the restricting pawl 82 with the external teeth 90 of the gear plate 66 of the rotation force transmission mechanism 50 (second FL mechanism 44).

Moreover, as illustrated in FIG. 5, in the pawl-locked state, the elongated hole 84 in the restricting pawl 82 is at an angle of θ with respect to the vehicle upper side end of the restriction portion 96 of the leg plate 16 of the frame 12. Accordingly, when the restricting pawl 82 attempts to move in the length direction of the elongated hole 84 such that the length direction base end of the elongated hole 84 in the restricting pawl 82 approaches the pawl support shaft 86 of the leg plate 16 of the frame 12, movement of the locking pin 92 of the restricting pawl 82 when the restricting pawl 82 moves is restricted by the vehicle upper side end of the restriction portion 96 of the leg plate 16 of the frame 12. Accordingly, in this state, the gear plate 66 of the rotation force transmission mechanism 50 (second FL mechanism 44) can be suppressed from swinging in the take-up direction (the arrow A direction in FIG. 5) accompanying the restricting pawl 82.

Moreover, as illustrated in FIG. 3, an urging spring 98 is provided at the vehicle front side of the leg plate 16 of the frame 12. The urging spring 98 is a torsion coil spring, and a portion of the urging spring 98 at a leading end side of a coil portion of the urging spring 98 is abutted by the locking pin 92 of the restricting pawl 82. The restricting pawl 82 is thereby urged toward the engagement direction (the arrow D direction in FIG. 3) about the pawl support shaft 86.

As illustrated in FIG. 1, the webbing take-up device 10 includes a trigger device 100 configuring a trigger section. The trigger device 100 includes a rod 102, serving as a trigger member. The rod 102 is formed in a rod shape, and the length direction of the rod 102 runs along the vehicle front-rear direction. The restricting pawl 82 is formed with a pawl hole 104 that a vehicle front side portion of the rod 102 is capable of passing through. The leg plate 16 of the frame 12 is formed with a leg plate hole 106 that the vehicle front side portion of the rod 102 is capable of passing through. As illustrated in FIG. 3, in a state in which the vehicle front side portion of the rod 102 has passed through the pawl hole 104 in the restricting pawl 82 and the leg plate hole 106 in the leg plate 16 of the frame 12, the restricting pawl 82 is retained by the rod 102 in a state in which the leading end side portion of the restricting pawl 82 is disposed outside of a circle described by leading ends of the external teeth 90 of the gear plate 66 of the rotation force transmission mechanism 50 (second FL mechanism 44).

A vehicle rear side portion of the rod 102 of the trigger device 100 passes through the leg plate 14 of the frame 12 to enter the inside of the pre-tensioner 28. As illustrated in FIG. 2, the trigger device 100 includes a trigger pawl 108. The pre-tensioner 28 is provided with a pawl shaft 109 corresponding to the trigger pawl 108. The axial direction of the pawl shaft 109 runs in the vehicle front-rear direction, and the trigger pawl 108 is supported by the pawl shaft 109 so as to be capable of swinging.

The trigger pawl 108 of the trigger device 100 includes a pinion engagement portion 110. The pinion engagement portion 110 engages with the pinion 30 of the pre-tensioner 28, and when the pinion 30 is rotated in the take-up direction (the arrow A direction in FIG. 2), the pinion engagement portion 110 is pressed by the external teeth of the pinion 30. The trigger pawl 108 thus swings in one direction (the arrow F direction in FIG. 2) about the pawl shaft 109. As illustrated in FIG. 2, the trigger device 100 includes a torsion coil spring 112. The torsion coil spring 112 is provided inside the pre-tensioner 28, and the trigger pawl 108 is urged toward the other direction (the arrow G direction in FIG. 2) about the pawl shaft 109 by the torsion coil spring 112.

The trigger pawl 108 further includes a rod-abutting portion 114. The rod-abutting portion 114 abuts a vehicle rear side end of the rod 102 inside the pre-tensioner 28, such that movement of the rod 102 of the trigger device 100 toward the vehicle rear side is restricted by the rod-abutting portion 114 of the trigger pawl 108. When the trigger pawl 108 swings in the one direction (the arrow F direction in FIG. 2) about the pawl shaft 109, a state in which the rod-abutting portion 114 of the trigger pawl 108 opposes the vehicle rear side end of the rod 102 is released, allowing the rod 102 to move toward the vehicle rear side. When the rod 102 moves toward the vehicle rear side, the vehicle front side portion of the rod 102 leaves the leg plate hole 106 in the leg plate 16 of the frame 12 and the pawl hole 104 in the restricting pawl 82, thereby releasing the retention of the restricting pawl 82 by the rod 102.

As illustrated in FIG. 1, the trigger device 100 further includes a rod urging mechanism 116. The rod urging mechanism 116 is provided at the vehicle front side of the leg plate 14 of the frame 12, and the rod 102 of the trigger device 100 passes through the rod urging mechanism 116. The rod urging mechanism 116 includes a compression coil spring 118, and the rod 102 is urged toward the vehicle rear side by the compression coil spring 118. Accordingly, when the state in which the rod-abutting portion 114 of the trigger pawl 108 opposes the vehicle rear side end of the rod 102 is released, the rod 102 moves toward the vehicle rear side as a result of urging force from the compression coil spring 118.

### First Exemplary Embodiment: Operation and Advantageous Effects

In the webbing take-up device 10, when an occupant seated in the vehicle seat puts on the webbing 22, the webbing 22 is pulled by the occupant, such that the spool body 20 of the spool 18 is rotated in the pull-out direction (the arrow B direction in FIG. 2 etc.), and the webbing 22 is pulled out from the spool body 20 of the spool 18. The webbing 22 that has been pulled out from the spool body 20 of the spool 18 in this manner is wrapped across the body of the occupant, and in this state, the tongue provided to the webbing 22 is engaged with the buckle of the seatbelt device, thus placing the webbing 22 in a fitted state over the body of the occupant.

Moreover, when the spool body 20 of the spool 18 is rotated in the pull-out direction (the arrow B direction in FIG. 2 etc.) due to the webbing 22 being pulled in this manner, the attachment portion 48 of the spool 18 is rotated together with the spool body 20 of the spool 18, and the support member 46 of the second FL mechanism 44, and also the carrier plate 52 of the rotation force transmission mechanism 50 (second FL mechanism 44), rotate in the pull-out direction (the arrow B direction in FIG. 3) together with the spool 18. When the carrier plate 52 rotates in the pull-out direction, the planetary gears 58 of the rotation force transmission mechanism 50 (second FL mechanism 44) orbit the support member 46 in the pull-out direction together with the carrier plate 52.

In this state, rotation of the gear plate 66 is not restricted. Accordingly, when the planetary gears 58 of the rotation force transmission mechanism 50 (second FL mechanism 44) orbit in the pull-out direction (the arrow B direction in FIG. 3), the second gears 64 of the planetary gears 58 receive a pressing reaction force from the sun gear 78 of the flywheel 74 of the second FL mechanism 44, causing the planetary gears 58 to revolve. The revolution of the planetary gears 58 is transmitted to the internal-toothed gear 68 of the gear plate 66 meshed with the first gears 62 of the planetary gears 58, thereby rotating the gear plate 66 in the pull-out direction. Accordingly, in this state, the flywheel 74 is suppressed from rotating even if the webbing 22 is pulled and the spool 18 is rotated in the pull-out direction.

In a vehicle emergency such as a vehicle collision, the lock mechanism 36 actuates. When the lock mechanism 36 actuates, the rotation of the rotating lock body of the lock mechanism 36 in the pull-out direction (the arrow B direction in FIG. 2 etc.) is restricted by the lock member of the lock mechanism 36. The rotating lock body of the lock mechanism 36 is connected to the spool body 20 of the spool 18 through the torsion bar 42 of the first FL mechanism 40. Accordingly, since pull-out direction rotation of the rotating lock body of the lock mechanism 36 is restricted, pull-out direction rotation of the spool 18 is also restricted. The webbing 22 is thereby restricted from being pulled out from the spool body 20 of the spool 18, enabling the body of the occupant to be restrained by the webbing 22, and thereby enabling the body of the occupant to be suppressed from moving toward the vehicle front side under inertia.

Moreover, in a vehicle emergency such as a vehicle collision, the pre-tensioner 28 actuates. When the pre-tensioner 28 actuates, the rack bar 34 of the pre-tensioner 28 moves obliquely toward the vehicle upper side (the arrow C direction in FIG. 2). Accordingly, the pinion 30 of the pre-tensioner 28 rotates in the take-up direction (the arrow A direction in FIG. 2). When the pinion 30 rotates in the take-up direction, the clutch 32 between the pinion 30 and the adaptor 24 actuates such that the pinion 30 and the adaptor 24 become mechanically linked through the clutch 32. Accordingly, take-up direction rotation of the pinion 30 is transmitted to the spool body 20 of the spool 18 through the adaptor 24, such that the spool body 20 of the spool 18 is rotated in the take-up direction. Accordingly, slack in the webbing 22 fitted over the body of the occupant is eliminated, such that the body of the occupant is more firmly restrained by the webbing 22, enabling the body of the occupant to be even more effectively suppressed from moving toward the vehicle front side under inertia.

Moreover, when the pinion 30 of the pre-tensioner 28 is rotated in the take-up direction (the arrow A direction in FIG. 2) as described above by actuation of the pre-tensioner 28, the pinion engagement portion 110 of the trigger pawl 108 of the trigger device 100 is pressed by the external teeth of the pinion 30. When the trigger pawl 108 thereby swings in the one direction (the arrow F direction in FIG. 2) about the pawl shaft 109 against the urging force of the torsion coil spring 112, the state in which the rod-abutting portion 114 of the trigger pawl 108 opposes the vehicle rear side end of the rod 102 of the trigger device 100 is released, such that the rod 102 is no longer restricted from moving toward the vehicle rear side.

When the rod 102 of the trigger device 100 is no longer restricted from moving toward the vehicle rear side, the rod 102 of the trigger device 100 is moved toward the vehicle rear side by the compression coil spring 118 of the rod urging mechanism 116 of the trigger device 100, such that the vehicle front side portion of the rod 102 leaves the pawl hole 104 in the restricting pawl 82 and the leg plate hole 106 of the leg plate 16 of the frame 12, such that the restricting pawl 82 is no longer retained by the rod 102. When the restricting pawl 82 is no longer retained by the rod 102, the restricting pawl 82 swings in the engagement direction (the arrow D direction in FIG. 3) about the pawl support shaft 86 as a result of the urging force of the urging spring 98. Accordingly, the engagement tooth 88 of the restricting pawl 82 engages with the external teeth 90 of the gear plate 66 as illustrated in FIG. 4.

However, in this state, the locking pin 92 of the restricting pawl 82 is capable of re-entering the guide hole 94 in the leg plate 16 of the frame 12 by swinging in the engagement-release direction (the arrow D direction in FIG. 4) about the pawl support shaft 86. Accordingly, in this state, the restricting pawl 82 is capable of swinging in the engagement-release direction (the arrow E direction in FIG. 4) about the pawl support shaft 86 against the urging force of the torsion coil spring 112, and the carrier plate 52 of the rotation force transmission mechanism 50 (the second FL mechanism 44) is capable of rotating in the take-up direction (the arrow A direction in FIG. 4) accompanying the take-up direction (the arrow A direction in FIG. 4) rotation of the spool 18.

After the pre-tensioner 28 has actuated in this manner, if the occupant attempts to move toward the vehicle front side under inertia, the webbing 22 is pulled by the body of the occupant. A rotational force in the pull-out direction (the arrow B direction in FIG. 2 etc.) is thus imparted to the spool body 20 of the spool 18. In cases in which the magnitude of the pull-out direction rotational force imparted to the spool body 20 of the spool 18 exceeds the magnitude required for the torsion bar 42 of the first FL mechanism 40 to undergo torsion deformation, the spool 18 rotates in the pull-out direction. The torsion bar 42 accordingly undergoes torsion deformation, such that the webbing 22 is pulled out from the spool body 20 of the spool 18 by an amount corresponding to the rotation amount of the spool 18, and the occupant moves toward the vehicle front side under inertia. Part of the pull-out direction rotational force acting on the spool 18, namely, part of the pulling force imparted to the webbing 22 by the body of the occupant, is absorbed due to being expended in the torsion deformation of the torsion bar 42.

When the spool 18 is rotated in the pull-out direction (the arrow B direction in FIG. 2 etc.), the gear plate 66 of the rotation force transmission mechanism 50 (second FL mechanism 44) is rotated in the pull-out direction (arrow B direction in FIG. 4), such that the engagement tooth 88 of the restricting pawl 82 is pressed toward the pull-out direction by the external teeth 90 of the gear plate 66. Accordingly, the restricting pawl 82 swings about the pawl support shaft 86 while moving in the length direction of the elongated hole 84 until the length direction leading end of the elongated hole 84 in the restricting pawl 82 abuts the pawl support shaft 86 of the leg plate 16 of the frame 12. The restricting pawl 82 is thus placed in the pawl-locked state as illustrated in FIG. 5.

In the pawl-locked state, the restricting pawl 82 is restricted from moving and swinging even if the external teeth 90 of the gear plate 66 of the rotation force transmission mechanism 50 (second FL mechanism 44) press the engagement tooth 88 of the restricting pawl 82 toward the pull-out direction (the arrow B direction in FIG. 5). Accordingly, in this state, pull-out direction rotation of the gear plate 66 is restricted by the restricting pawl 82. In the rotation force transmission mechanism 50 of the second FL mechanism 44, the gear plate 66 that configures an internal gear is thus fixed, configuring a planetary gear train in which the speed of rotation input to the carrier plate 52 is boosted and transmitted to the sun gear 78 of the flywheel 74 through the planetary gears 58.

When this occurs, if the pull-out direction (the arrow B direction in FIG. 2 etc.) rotation of the spool 18 speeds up, rotation of the flywheel 74 of the second FL mechanism 44 is also sped up, causing inertial force to act on the flywheel 74 in the opposite direction to the rotation direction of the flywheel 74. The inertial force that acts on the flywheel 74 is transmitted to the attachment portion 48 of the spool 18 as a rotation-resisting force against the pull-out direction rotation of the spool 18. In this state, the magnitude of the pull-out direction rotational force imparted to the spool 18 exceeds the sum of the magnitude required to cause the torsion bar 42 of the first FL mechanism 40 to undergo torsion deformation and a magnitude to resist the inertial force acting on the flywheel 74, causing the spool 18 to rotate in the pull-out direction.

Accordingly, the webbing 22 is further pulled out from the spool body 20 of the spool 18 by an amount corresponding to the rotation amount of the spool 18, such that the occupant moves toward the vehicle front side under inertia. Moreover, part of the pull-out direction (arrow B direction in FIG. 2 etc.) rotational force of the spool 18, namely, part of the pulling force imparted to the webbing 22 from the body of the occupant, is absorbed due to being expended in the torsion deformation of the torsion bar 42 of the first FL mechanism 40, and in the rotational force resisting the inertial force of the flywheel 74 of the second FL mechanism 44.

On the other hand, when the movement speed of the occupant toward the vehicle front side under inertia decreases, and the pulling on the webbing 22 by the body of the occupant consequently becomes weaker, the rotation speed of the spool 18 in the pull-out direction (the arrow B direction in FIG. 2 etc.) becomes slower. However, deceleration of the rotation of the flywheel 74 of the second FL mechanism 44 is suppressed due to inertia. Accordingly, in this state, the rotational force of the flywheel 74 rotating under inertia becomes greater than the rotational force transmitted to the flywheel 74 from the spool 18. The rotation of the flywheel 74 caused by inertia is transmitted to the internal-toothed gear 68 of the gear plate 66 by the sun gear 78 of the flywheel 74, the second gears 64 of the planetary gears 58, and the first gears 62 of the planetary gears 58, and attempts to rotate the gear plate 66 in the take-up direction (the arrow A direction in FIG. 5).

In this state, the locking pin 92 of the restricting pawl 82 abuts the vehicle upper side end of the restriction portion 96 of the leg plate 16 of the frame 12, thereby restricting swinging of the restricting pawl 82 toward the engagement-release direction (the arrow E direction in FIG. 5) about the pawl support shaft 86. Accordingly, the meshing of the engagement tooth 88 of the restricting pawl 82 with the external teeth 90 of the gear plate 66 is not released, even if the gear plate 66 of the rotation force transmission mechanism 50 (second FL mechanism 44) attempts to rotate in the take-up direction (the arrow A direction in FIG. 5). Moreover, in this state, the elongated hole 84 in the restricting pawl 82 is at the angle θ with respect to the vehicle upper side end of the restriction portion 96 of the leg plate 16 of the frame 12. Accordingly, when the restricting pawl 82 attempts to move as a result of take-up direction rotation of the gear plate 66, movement of the locking pin 92 of the restricting pawl 82 is restricted by the vehicle upper side end of the restriction portion 96 of the leg plate 16 of the frame 12.

Accordingly, in the pawl-locked state, rotation of the gear plate 66 of the rotation force transmission mechanism 50 (second FL mechanism 44) in the take-up direction (the arrow A direction in FIG. 5) is restricted. Rotation is therefore transmitted between the spool 18 and the flywheel 74 irrespective of the rotation direction and rotational acceleration of the spool 18, and of the rotational acceleration of the flywheel 74 of the second FL mechanism 44. Accordingly, in this state, the rotational force of the inertial rotation of the flywheel 74 of the second FL mechanism 44 is transmitted to the spool 18 through the sun gear 78 of the flywheel 74, the planetary gears 58, the carrier plate 52, and the support member 46 as a rotational force in the pull-out direction (the arrow B direction in FIG. 2 etc.).

Accordingly, even if the movement speed of the body of the occupant toward the vehicle front side under inertia were to decrease, the rotation force from the inertial rotation of the flywheel 74 of the second FL mechanism 44 acts as if to rotate the spool 18 in the pull-out direction (the arrow B direction in FIG. 2 etc.), enabling the load received by the body of the occupant from the webbing 22 to be alleviated.

In this manner, in the webbing take-up device 10, rotation of the spool 18 in the take-up direction (the arrow A direction in FIG. 2 etc.) can be prevented or suppressed from being transmitted to the flywheel 74 of the second FL mechanism 44 when the pre-tensioner 28 has been actuated. As a result, the output of the pre-tensioner 28, namely, a take-up direction rotational force on the pinion 30 resulting from actuation of the pre-tensioner 28, can be effectively utilized to rotate the spool body 20 of the spool 18 in the take-up direction.

Moreover, when the pre-tensioner 28 actuates, the engagement tooth 88 of the restricting pawl 82 meshes with the external teeth 90 of the gear plate 66 of the rotation force transmission mechanism 50 (second FL mechanism 44), and in this state, the restricting pawl 82 moves together with the gear plate 66 that is rotating in the pull-out direction (the arrow B direction in FIG. 5), such that the restricting pawl 82 adopts the pawl-locked state. When this occurs, the restricting pawl 82 is capable of restricting not only rotation of the gear plate 66 in the pull-out direction, but also rotation of the gear plate 66 in the take-up direction (the arrow A direction in FIG. 5). Accordingly, when the speed of the movement of the occupant toward the vehicle front side under inertia has decreased, rotational force of the inertial rotation of the flywheel 74 can be transmitted to the spool 18, enabling the load received by the body of the occupant from the webbing 22 to be alleviated.

Moreover, when the pre-tensioner 28 actuates, the retention of the restricting pawl 82 by the rod 102 of the trigger device 100 is released as a result of the pinion 30 of the pre-tensioner 28 rotating in the take-up direction (the arrow A direction in FIG. 2), thereby causing the engagement tooth 88 of the restricting pawl 82 to mesh with the external teeth 90 of the gear plate 66. Accordingly, in a state prior to actuation of the pre-tensioner 28, rotation of the spool 18 can be suppressed from being transmitted to the flywheel 74 of the second FL mechanism 44. Accordingly, inertial force of the flywheel 74 of the second FL mechanism 44 can be suppressed from resisting the pulling on the webbing 22 by the occupant when the occupant is putting on the webbing 22.

When the pinion 30 of the pre-tensioner 28 is rotated in the take-up direction (the arrow A direction in FIG. 2), the pinion engagement portion 110 of the trigger pawl 108 of the trigger device 100 is pressed by the external teeth of the pinion 30 such that the trigger pawl 108 swings. The rod 102 of the trigger device 100 is moved as a result, such that the restricting pawl 82 is no longer retained by the rod 102. In this manner, actuation of the restricting pawl 82 is mechanically coordinated with actuation of the pre-tensioner 28. This thereby enables a reduction in costs in comparison to a configuration in which, for example, retention and retention-release of the restricting pawl 82 are performed using a drive section such as a solenoid or motor, with actuation of the drive section being electrically coordinated with actuation of the pre-tensioner 28.

### Second Exemplary Embodiment

### Explanation Follows Regarding a Second Exemplary Embodiment

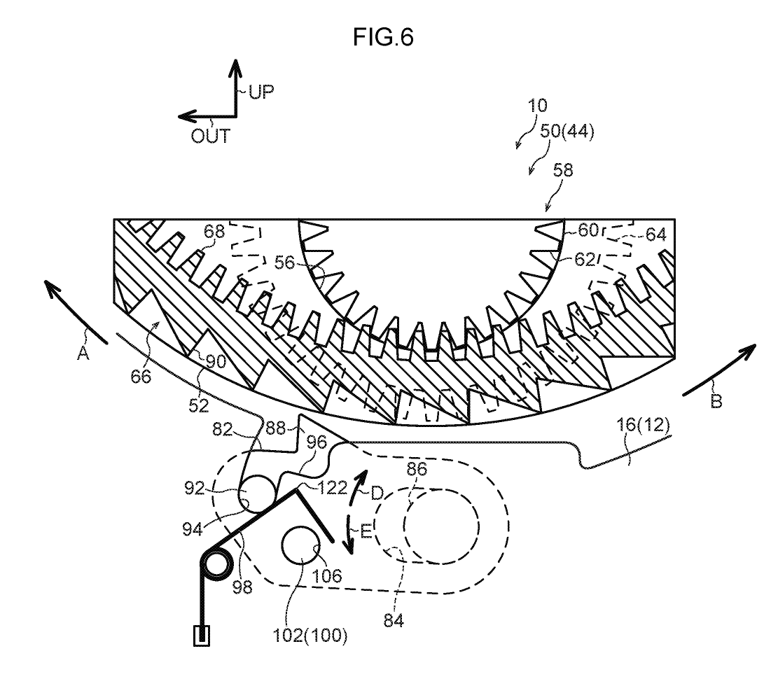

As illustrated in FIG. 6, in the second exemplary embodiment, a portion of the urging spring 98 further toward a leading end side than the coil portion is formed with a bent portion 122. The portion of the urging spring 98 further toward the leading end side than the coil portion is bent at the bent portion 122. A portion of the urging spring 98 between the coil portion and the bent portion 122 is abutted by the locking pin 92 of the restricting pawl 82 when the restricting pawl 82 is in a state retained by the rod 102 of the trigger device 100. The restricting pawl 82 is urged toward the engagement direction (the arrow D direction in FIG. 6) about the pawl support shaft 86 by the urging force of the urging spring 98. Accordingly, when the restricting pawl 82 is no longer retained by the rod 102 of the trigger device 100, the locking pin 92 of the restricting pawl 82 is pressed by the portion of the urging spring 98 between the coil portion and the bent portion 122, such that the restricting pawl 82 swings in the engagement direction about the pawl support shaft 86.

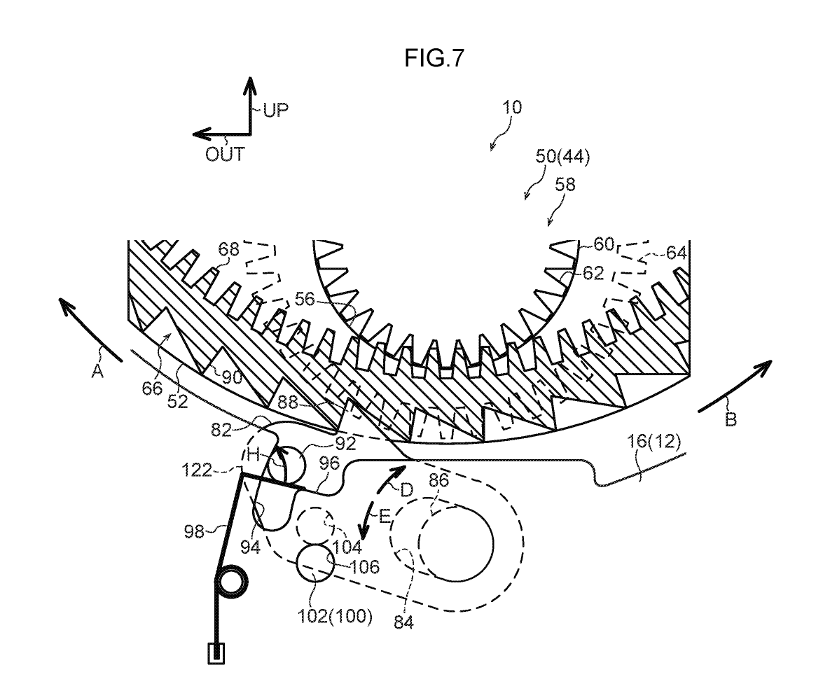

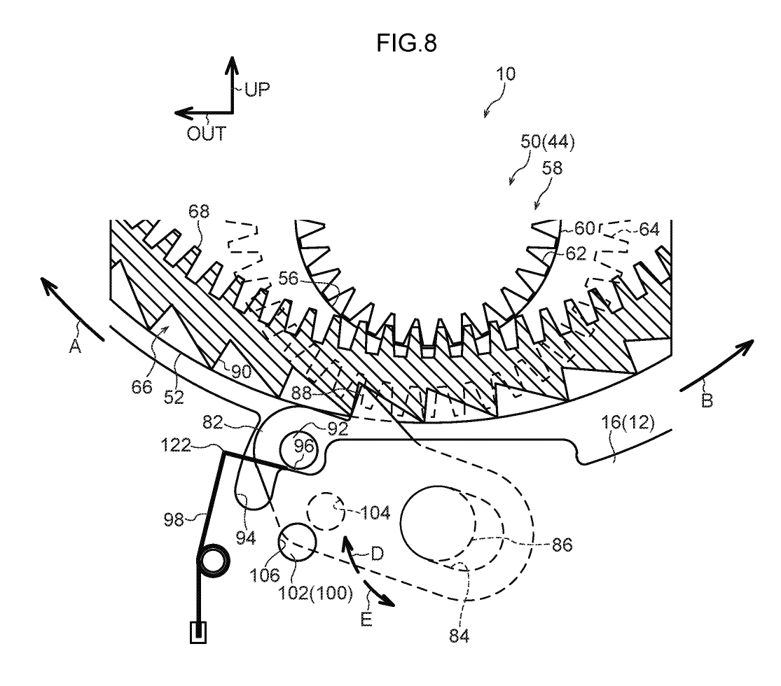

Moreover, as illustrated in FIG. 7, when the engagement tooth 88 of the restricting pawl 82 meshes with the external teeth 90 of the gear plate 66, the abutting of the locking pin 92 of the restricting pawl 82 by the portion of the urging spring 98 between the coil portion and the bent portion 122 is released, attaining a state in which load does not act on the portion of the urging spring 98 between the coil portion and the bent portion 122 (see FIG. 7 and FIG. 8). The position for forming the bent portion 122 of the urging spring 98, the length of the urging spring 98 on the leading end side of the coil portion, and the like are set such that the portion of the urging spring 98 further toward the leading end side than the bent portion 122 is disposed at the vehicle upper side of the guide hole 94 of the leg plate 16 of the frame 12 when in this state.

In the present exemplary embodiment, as illustrated in FIG. 7, when the gear plate 66 of the rotation force transmission mechanism 50 (second FL mechanism 44) rotates in the pull-out direction (the arrow B direction in FIG. 7) in a state in which the engagement tooth 88 of the restricting pawl 82 is meshed with the external teeth 90 of the gear plate 66, the engagement tooth 88 of the restricting pawl 82 is pressed by the external teeth 90 of the gear plate 66. Accordingly, the restricting pawl 82 swings about the pawl support shaft 86 while moving in the length direction of the elongated hole 84 until the length direction leading end of the elongated hole 84 in the restricting pawl 82 is abutted by the pawl support shaft 86 of the leg plate 16 of the frame 12. The restricting pawl 82 is thus placed in the pawl-locked state, as illustrated in FIG. 8.

In the pawl-locked state, when the gear plate 66 of the rotation force transmission mechanism 50 (second FL mechanism 44) attempts to rotate in the take-up direction (the arrow A direction in FIG. 8), the engagement tooth 88 of the restricting pawl 82 receives pressing force from the external teeth 90 of the gear plate 66. Accordingly, even if as illustrated in FIG. 7, the restricting pawl 82 has moved as far as a position at which the locking pin 92 of the restricting pawl 82 is disposed at the vehicle upper side of the guide hole 94 in the leg plate 16 of the frame 12, in this state, the portion of the urging spring 98 further toward the leading end side than the bent portion 122 is disposed at the vehicle upper side of the guide hole 94 in the leg plate 16 of the frame 12, such that the locking pin 92 of the restricting pawl 82 is disposed on the opposite side of the portion of the urging spring 98 further toward the leading end side than the bent portion 122 to the guide hole 94 in the leg plate 16.

In such a state, the engagement tooth 88 of the restricting pawl 82 receives pressing force from the external teeth 90 of the gear plate 66 of the rotation force transmission mechanism 50 (second FL mechanism 44), and when the restricting pawl 82 attempts to swing in the engagement-release direction (the arrow E direction in FIG. 6) about the pawl support shaft 86, the portion of the urging spring 98 further toward the leading end side than the bent portion 122 is pressed toward the vehicle lower side by the locking pin 92 of the restricting pawl 82. Since the urging spring 98 is a spring, when the portion of the urging spring 98 further toward the leading end side than the bent portion 122 is pressed toward the vehicle lower side by the locking pin 92 of the restricting pawl 82, the locking pin 92 of the restricting pawl 82 is pushed back toward the arrow H direction in FIG. 7 by urging force from the portion of the urging spring 98 further toward the leading end side than the bent portion 122. This thereby enables the locking pin 92 of the restricting pawl 82 to be prevented or suppressed from returning to the inside of the guide hole 94 in the leg plate 16 of the frame 12, enabling the meshing of the engagement tooth 88 of the restricting pawl 82 with the external teeth 90 of the gear plate 66 to be prevented or suppressed from being released.

In the present exemplary embodiment, in the pawl-locked state illustrated in FIG. 8, there is no need to give particular consideration to the angle of the length direction of the elongated hole 84 in the restricting pawl 82 with respect to the vehicle upper side end of the restriction portion 96 of the leg plate 16 of the frame 12. For example, this enables the shapes of the respective components, including the formation position of the elongated hole 84 in the restricting pawl 82, and the formation position of the guide hole 94 in the leg plate 16 of the frame 12, to be designed with greater degrees of freedom.

Moreover, the present exemplary embodiment has the same basic configuration as the first exemplary embodiment, with the exception of the configuration of the urging spring 98. The present exemplary embodiment is thus capable of obtaining similar advantageous effects to those of the first exemplary embodiment.

### Third Exemplary Embodiment

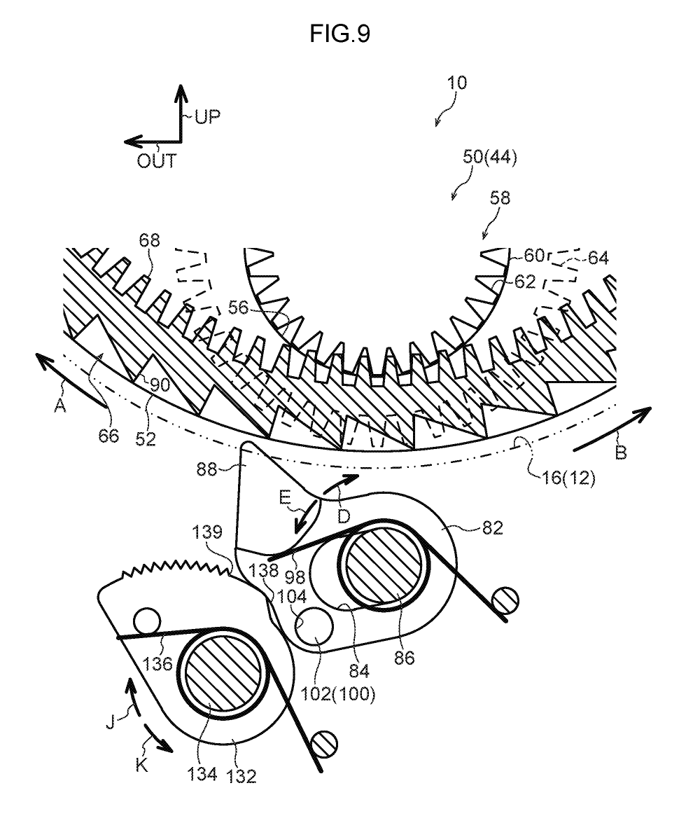

Explanation follows regarding a third exemplary embodiment. In FIG. 9 to FIG. 11, used to explain the present exemplary embodiment, the leg plate 16 of the frame 12 is illustrated by imaginary lines (double-dotted dashed lines).

As illustrated in FIG. 9, in the third exemplary embodiment, the locking pin 92 is not formed to the restricting pawl 82, and the leg plate 16 of the frame 12 is not formed with the guide hole 94.

Moreover, in the present exemplary embodiment, a pawl stopper 132, serving as a retention member, is provided at the vehicle rear side of the leg plate 16 of the frame 12. A shaft 134 is provided at the vehicle rear side of the leg plate 16 of the frame 12. The shaft 134 is disposed closer toward a length direction leading end side of the elongated hole 84 in the restricting pawl 82 than to the pawl support shaft 86, and the axial direction of the shaft 134 runs along the vehicle front-rear direction. The shaft 134 is supported by the leg plate 16 of the frame 12, or is integrally provided to the leg plate 16 of the frame 12, and the pawl stopper 132 is supported so as to be capable of swinging by the shaft 134.

The leg plate 16 of the frame 12 is provided with a stopper urging spring 136, such that the pawl stopper 132 is urged in one direction (the arrow J direction in FIG. 9) about the shaft 134 by the stopper urging spring 136. A pawl-abutting portion 138 configuring part of an outer peripheral face of the pawl stopper 132 accordingly abuts part of an outer peripheral face of the restricting pawl 82. Accordingly, the restricting pawl 82 is capable of swinging about the pawl support shaft 86 in a state in which the pawl-abutting portion 138 of the pawl stopper 132 abuts part of the outer peripheral face of the restricting pawl 82.

The pawl stopper 132 is formed with a swing restricting portion 139. The swing restricting portion 139 configures a portion of the outer peripheral face of the pawl stopper 132 further toward the other direction side (the arrow K direction side in FIG. 9) about the shaft 134 than the pawl-abutting portion 138. The distance of the swing restricting portion 139 of the pawl stopper 132 from the swing center of the pawl stopper 132 (namely, the shaft 134) increases on progression toward the other direction (the arrow K direction in FIG. 9) about the shaft 134. Moreover, a portion of the swing restricting portion 139 of the pawl stopper 132 is configured with an undulating shape of alternate peaks and troughs following an outer peripheral direction of the pawl stopper 132.

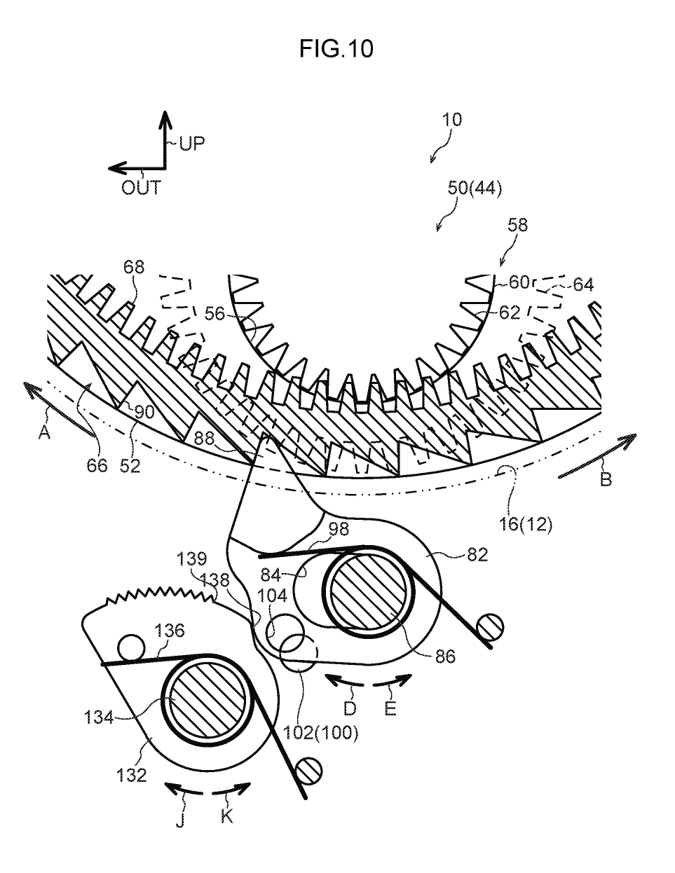

In the present exemplary embodiment configured as described above, when the restricting pawl 82 is no longer retained by the rod 102 of the trigger device 100, the restricting pawl 82 swings in the engagement direction (the arrow D direction in FIG. 9) about the pawl support shaft 86, such that as illustrated in FIG. 10, the engagement tooth 88 of the restricting pawl 82 meshes with external teeth 90 of the gear plate 66 of the rotation force transmission mechanism 50 (second FL mechanism 44). In this state, the gear plate 66 rotates in the pull-out direction (the arrow B direction in FIG. 9) as a result of the rotation of the spool 18 in the take-up direction (the arrow A direction in FIG. 9 etc.), and the engagement tooth 88 of the restricting pawl 82 is pressed by the external teeth 90 of the gear plate 66. When this occurs, the restricting pawl 82 swings about the pawl support shaft 86 while moving in the length direction of the elongated hole 84 until the length direction leading end of the elongated hole 84 in the restricting pawl 82 is abutted by the pawl support shaft 86 of the leg plate 16 of the frame 12.

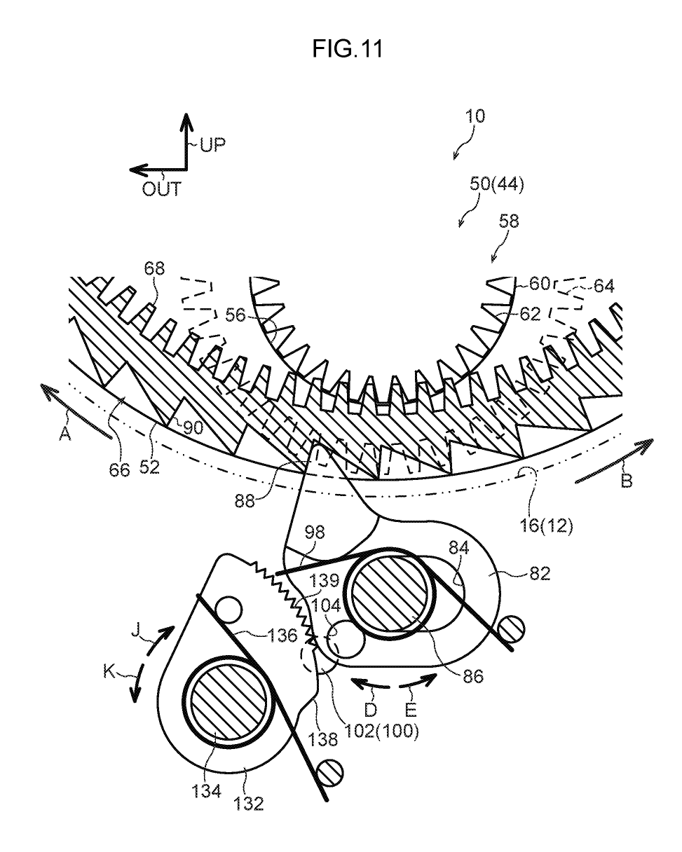

When the restricting pawl 82 separates from the pawl stopper 132 due to the restricting pawl 82 swinging and moving in the length direction of the elongated hole 84 in this manner, the pawl stopper 132 is swung in the one direction (the arrow J direction in FIG. 10) about its shaft by the urging force of the stopper urging spring 136. Accordingly, as illustrated in FIG. 11, the swing restricting portion 139 of the pawl stopper 132 is abutted from the engagement-release direction (the arrow E direction in FIG. 11) side about the pawl support shaft 86 by an outer peripheral portion of the restricting pawl 82. Accordingly, movement of the restricting pawl 82 in a direction in which the length direction base end of the elongated hole 84 in the restricting pawl 82 approaches the pawl support shaft 86 is prevented or suppressed.

Moreover, in this state, supposing the restricting pawl 82 were to swing in the engagement-release direction (the arrow E direction side in FIG. 11) about the pawl support shaft 86, friction between the outer peripheral face of the restricting pawl 82 and the swing restricting portion 139 of the pawl stopper 132 would swing the pawl stopper 132 in the one direction (the arrow J direction in FIG. 9) about the shaft 134. Accordingly, the outer peripheral face of the restricting pawl 82 would be abutted by a portion of the swing restricting portion 139 of the pawl stopper 132 that is further than previously toward the other direction about the shaft 134.

Note that the swing restricting portion 139 of the pawl stopper 132 is located a large distance in the other direction (the arrow K direction in FIG. 9) about the shaft 134 from the swing center (namely, the shaft 134) of the pawl stopper 132. Accordingly, in a state in which the swing restricting portion 139 of the pawl stopper 132 is abutted by the outer peripheral face of the restricting pawl 82, the pawl stopper 132 is prevented or suppressed from swinging in the one direction about the shaft 134.

In this manner, in the present exemplary embodiment, in the pawl-locked state of the restricting pawl 82 (the state illustrated in FIG. 11) in which the engagement tooth 88 of the restricting pawl 82 and the external teeth 90 of the gear plate 66 of the rotation force transmission mechanism 50 (the second FL mechanism 44) are meshed with each other, and the length direction leading end of the elongated hole 84 in the restricting pawl 82 is abutted by the pawl support shaft 86, movement of the restricting pawl 82 in the direction in which the length direction base end of the elongated hole 84 in the restricting pawl 82 approaches the pawl support shaft 86 is prevented or suppressed. Accordingly, the restricting pawl 82 is prevented or suppressed from swinging in the engagement-release direction (the arrow E direction in FIG. 11) about the pawl support shaft 86, such that the meshing of the engagement tooth 88 of the restricting pawl 82 with the external teeth 90 of the gear plate 66 is maintained. Accordingly, in the pawl-locked state illustrated in FIG. 11, the gear plate 66 can be prevented or suppressed from rotating in both the pull-out direction (the arrow B direction in FIG. 11) and the take-up direction (the arrow A direction in FIG. 11).

Moreover, the present exemplary embodiment has the same basic configuration as the first exemplary embodiment, with the exception of the configuration by which the restricting pawl 82 is prevented or suppressed from moving in the direction in which the length direction base end of the elongated hole 84 in the restricting pawl 82 approaches the pawl support shaft 86 when in the pawl-locked state, and the configuration by which the restricting pawl 82 is prevented or suppressed from swinging in the engagement-release direction (the arrow E direction in FIG. 11) about the pawl support shaft 86. The present exemplary embodiment is thus capable of obtaining similar advantageous effects to those of the first exemplary embodiment.

### Fourth Exemplary Embodiment

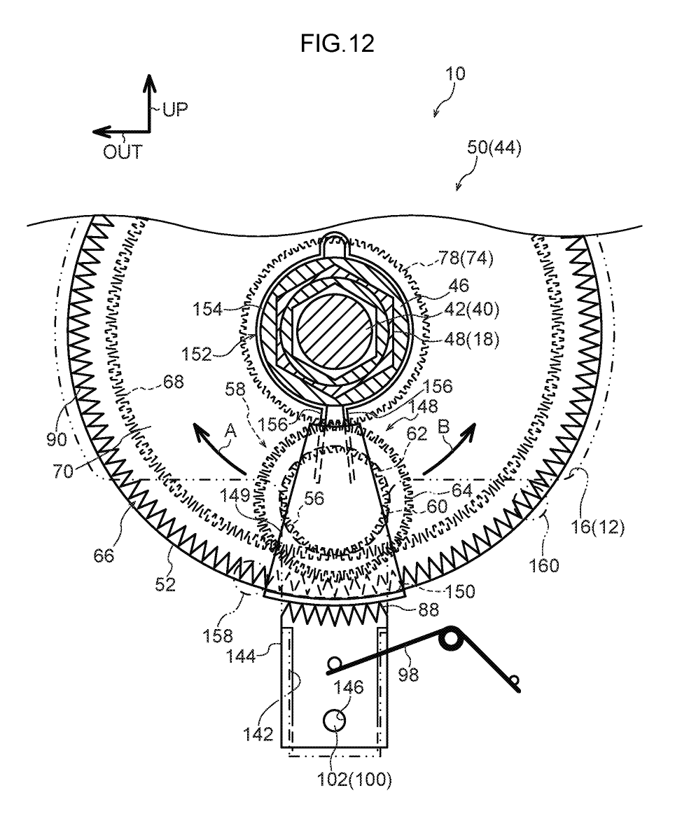

Explanation follows regarding a fourth exemplary embodiment. In FIG. 12 to FIG. 14, used to explain the present exemplary embodiment, the leg plate 16 of the frame 12 is illustrated by imaginary lines (double-dotted dashed lines).

As illustrated in FIG. 12, in the fourth exemplary embodiment, the external teeth 90 of the gear plate 66 of the rotation force transmission mechanism 50 (second FL mechanism 44) are configured with isosceles triangle profiles, and do not configure a ratchet profile. In the present exemplary embodiment, the leg plate 16 of the frame 12 is formed with a slider placement portion 142. The slider placement portion 142 is an elongated substantially rectangular hole running in the vehicle up-down direction as viewed along the vehicle front-rear direction. A slider 144, serving as a restricting member of a clutch mechanism, is disposed in the slider placement portion 142 of the leg plate 16 of the frame 12.

The slider 144 has an elongated substantially rectangular plate shape or block shape running along the vehicle up-down direction as viewed along the vehicle front-rear direction, and elongated grooves running in the vehicle up-down direction are formed at both width direction (vehicle width direction) end portions of the slider 144. Both width direction (vehicle width direction) end portions of the slider placement portion 142 of the frame 12 slot into the respective grooves formed at both width direction end portions of the slider 144. The slider 144 is thus capable of sliding in the vehicle up-down direction, guided by both width direction end portions of the slider placement portion 142 of the frame 12.

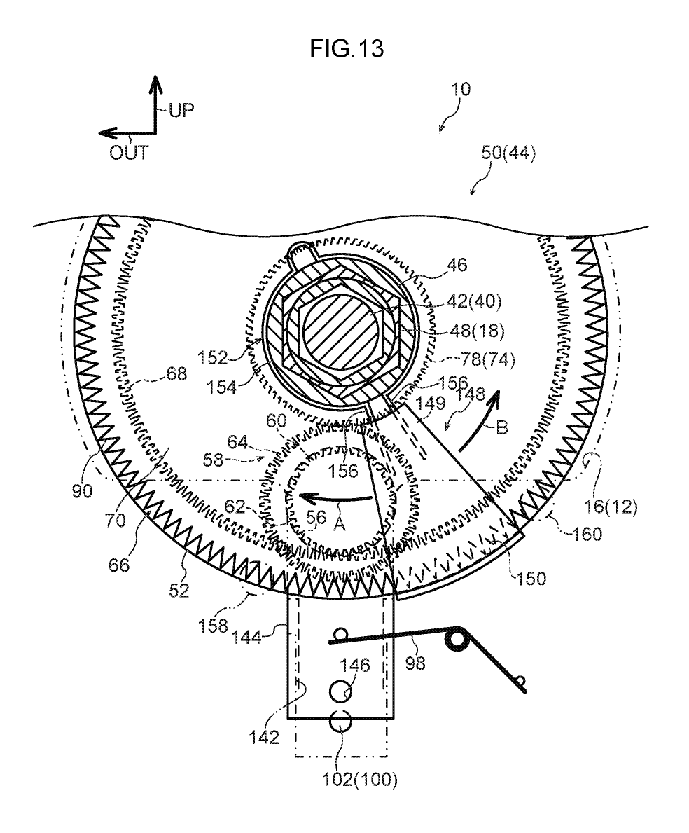

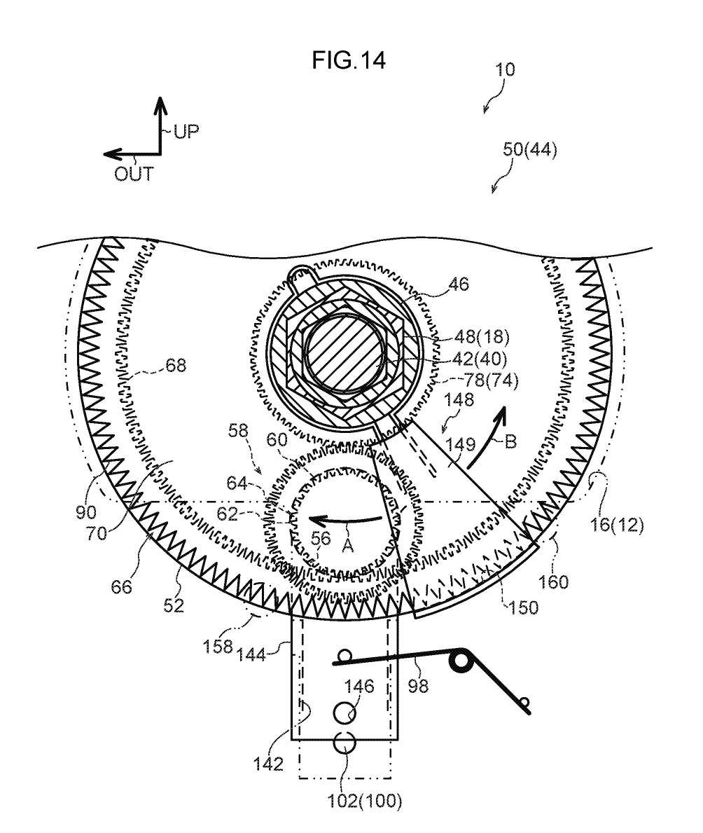

Engagement teeth 88 are formed at a vehicle upper side end portion of the slider 144. The engagement teeth 88 of the slider 144 differ from the engagement tooth 88 of the restricting pawl 82 in the first exemplary embodiment to the third exemplary embodiment in that they are configured with isosceles triangle profiles. When the slider 144 slides toward the vehicle upper side, as illustrated in FIG. 13 and FIG. 14, the engagement teeth 88 of the slider 144 are capable of meshing with the external teeth 90 of the gear plate 66 of the rotation force transmission mechanism 50 (second FL mechanism 44). When the engagement teeth 88 of the slider 144 mesh with the external teeth 90 of the gear plate 66, the gear plate 66 is restricted from rotating in both the take-up direction (the arrow A direction in FIG. 13 and FIG. 14) and the pull-out direction (the arrow B direction in FIG. 13 and FIG. 14).

A portion of an urging spring 98 further toward the leading end side than the coil portion engages with the slider 144, such that the slider 144 is urged toward the vehicle upper side by the urging spring 98. The slider 144 is also formed with a slider hole 146. The slider hole 146 penetrates the slider 144 in the thickness direction of the slider 144 (the vehicle front-rear direction). A vehicle front side portion of the rod 102 of the trigger device 100 is disposed passing through the slider hole 146 in the slider 144 in a state in which the engagement teeth 88 of the slider 144 are disposed outside a circle described by leading ends of the external teeth 90 of the gear plate 66 of the rotation force transmission mechanism 50 (second FL mechanism 44). Accordingly, the slider 144 is retained by the rod 102 of the trigger device 100 in a state in which the engagement teeth 88 of the slider 144 are disposed outside the circle described by the leading ends of the external teeth 90 of the gear plate 66.

A stopper plate 148, serving as a blocking member, is provided at the vehicle rear side of the leg plate 16 of the frame 12. The stopper plate 148 includes a plate portion 149. The plate portion 149 is formed in a plate shape, and the thickness direction of the plate portion 149 runs along the vehicle front-rear direction. The plate portion 149 is configured substantially in a spreading fan shape as viewed along the vehicle front-rear direction, and the center (the center of the spreading fan shape) of the plate portion 149 is disposed on a side corresponding to the axial center of the spool 18. A plate abutting portion 150 is formed at a radial direction outside end portion of the plate portion 149. The plate abutting portion 150 extends from the radial direction outside end portion of the plate portion 149 of the stopper plate 148 toward the vehicle rear side, and the plate abutting portion 150 opposes the external teeth 90 of the gear plate 66 along the radial direction of the plate portion 149 and of the gear plate 66 of the rotation force transmission mechanism 50 (second FL mechanism 44).

The stopper plate 148 is further provided with a friction spring 152. The friction spring 152 includes an attachment portion 154. The attachment portion 154 of the friction spring 152 is formed in a substantially C shape as viewed along the vehicle front-rear direction, and wraps around a vehicle front side end portion of the support member 46 of the second FL mechanism 44. The attachment portion 48 of the friction spring 152 is in elastic pressing contact with the outer peripheral face of the support member 46 of the second FL mechanism 44, such that when the support member 46 rotates together with the spool 18, friction between the attachment portion 48 of the friction spring 152 and the outer peripheral face of the support member 46 of the second FL mechanism 44 causes the friction spring 152 to rotate together with the support member 46. The support member 46 is capable of rotating relative to the friction spring 152 when rotational force imparted to the support member 46 exceeds the frictional force between the attachment portion 154 of the friction spring 152 and the outer peripheral face of the support member 46.

The friction spring 152 further includes a pair of legs 156. The two legs 156 extend from the two peripheral direction ends of the attachment portion 154 of the friction spring 152 toward the radial direction outside of the attachment portion 154, and leading end portions of the legs 156 of the friction spring 152 are anchored to a radial direction inside portion of the plate portion 149 of the stopper plate 148. Accordingly, when the friction spring 152 of the stopper plate 148 swings about the support member 46 of the second FL mechanism 44, the plate portion 149 of the stopper plate 148 swings together with the friction spring 152.

The leg plate 16 of the frame 12 is provided with a first pin 158. The first pin 158 projects from the leg plate 16 of the frame 12 toward the vehicle rear side. The first pin 158 opposes the plate portion 149 of the stopper plate 148 on the take-up direction side (the arrow A direction side in FIG. 12 etc.) of the plate portion 149 of the stopper plate 148, and the plate portion 149 of the stopper plate 148 abuts the first pin 158, thereby restricting rotation of the stopper plate 148 in the take-up direction (the arrow A direction in FIG. 12 etc.). In this manner, in a state in which the plate portion 149 of the stopper plate 148 is abutted by the first pin 158, the plate abutting portion 150 of the stopper plate 148 opposes the slider 144 at the vehicle upper side of the slider 144. In this state, the slider 144 is restricted from sliding toward the vehicle upper side.

The leg plate 16 of the frame 12 is also provided with a second pin 160. The second pin 160 projects from the leg plate 16 of the frame 12 toward the vehicle rear side. The second pin 160 opposes the plate portion 149 of the stopper plate 148 at the pull-out direction (the arrow B direction in FIG. 12) side of the plate portion 149 of the stopper plate 148, and when the plate portion 149 of the stopper plate 148 is abutted by the second pin 160 as illustrated in FIG. 13, the stopper plate 148 is restricted from rotating in the pull-out direction (the arrow B direction in FIG. 13). Accordingly, in a state in which the plate portion 149 of the stopper plate 148 is abutted by the second pin 160, the slider 144 is no longer opposed by the plate abutting portion 150 of the stopper plate 148 in the vehicle up-down direction, and in this state, the slider 144 is capable of sliding toward the vehicle upper side.

In the present exemplary embodiment configured as described above, the trigger device 100 is actuated by actuation of the pre-tensioner 28, thereby releasing the retention of the slider 144 by the rod 102 of the trigger device 100.

On the other hand, when the pre-tensioner 28 is actuated such that the spool 18 is rotated in the take-up direction (the arrow A direction in FIG. 12), and the support member 46 of the second FL mechanism 44 rotates in the take-up direction together with the spool 18, the stopper plate 148 attempts to rotate in the take-up direction as a result of the friction between the attachment portion 154 of the friction spring 152 of the stopper plate 148 and the outer peripheral portion of the support member 46. In this state, the plate portion 149 of the stopper plate 148 is abutted by the first pin 158 of the leg plate 16 of the frame 12, such that the first pin 158 restricts take-up direction rotation of the stopper plate 148.

Accordingly, in the state in which the pre-tensioner 28 has been actuated such that the spool 18 is rotated in the take-up direction (the arrow A direction in FIG. 12), the plate portion 149 of the stopper plate 148 is retained in a state abutted by the first pin 158. In this state, the plate abutting portion 150 of the stopper plate 148 opposes the slider 144 at the vehicle upper side of the slider 144. Accordingly, in this state, the stopper plate 148 is restricted from sliding toward the vehicle upper side.

Accordingly, in this state, the gear plate 66 is capable of rotating in both the take-up direction (the arrow A direction in FIG. 12) and the pull-out direction (the arrow B direction in FIG. 12). The take-up direction rotation of the spool 18 is transmitted to the gear plate 66 through the carrier plate 52 and the planetary gears 58, thereby rotating the gear plate 66 in the take-up direction. Accordingly, in this state, rotational force of the spool 18 can be suppressed from being transmitted to the flywheel 74 of the second FL mechanism 44, enabling take-up direction rotational force imparted to the pinion 30 as a result of actuation of the pre-tensioner 28 to be effectively utilized in take-up direction rotation of the spool body 20 of the spool 18.

Following actuation of the pre-tensioner 28, the webbing 22 is pulled by the body of the occupant attempting to move toward the vehicle front side under inertia, thereby rotating the spool 18 in the pull-out direction (the arrow B direction in FIG. 12 etc.). When the spool 18 rotates in the pull-out direction in this manner, the support member 46 of the second FL mechanism 44 is rotated in the pull-out direction (the arrow B direction in FIG. 12 etc.) together with the spool 18, and the stopper plate 148 is rotated in the pull-out direction together with the support member 46 as a result of the friction between the attachment portion 154 of the friction spring 152 of the stopper plate 148 and the outer peripheral face of the support member 46. In this manner, as illustrated in FIG. 13, the stopper plate 148 rotates in the pull-out direction such that the plate portion 149 of the stopper plate 148 is abutted by the second pin 160 of the leg plate 16 of the frame 12, such that the second pin 160 restricts the stopper plate 148 from rotating in the pull-out direction (the arrow B direction in FIG. 13).

The slider 144 is thus no longer restricted from sliding toward the vehicle upper side by the plate abutting portion 150 of the plate portion 149 of the stopper plate 148. In this state, since the slider 144 is no longer retained by the rod 102 of the trigger device 100, the slider 144 slides toward the vehicle upper side as a result of the urging force of the urging spring 98. The engagement teeth 88 of the slider 144 accordingly mesh with the external teeth 90 of the gear plate 66 of the rotation force transmission mechanism 50 (second FL mechanism 44), thus restricting rotation of the gear plate 66 in both the take-up direction (the arrow A direction in FIG. 13) and the pull-out direction (the arrow B direction in FIG. 13).

Moreover, in the state in which the engagement teeth 88 of the slider 144 have meshed with the external teeth 90 of the gear plate 66 of the rotation force transmission mechanism 50 (second FL mechanism 44), when the support member 46 of the second FL mechanism 44 rotates in the take-up direction (the arrow A direction in FIG. 13) together with the spool 18, the stopper plate 148 also rotates in the take-up direction. However, when the stopper plate 148 rotates in the take-up direction in this state, the plate portion 149 of the stopper plate 148 is abutted by the slider 144 from the pull-out direction side (the arrow B direction side in FIG. 13) of the slider 144 (see FIG. 14). The plate abutting portion 150 of the stopper plate 148 therefore does not enter between the engagement teeth 88 of the slider 144 and the external teeth 90 of the gear plate 66, enabling the meshing of the engagement teeth 88 of the slider 144 with the external teeth 90 of the gear plate 66 to be maintained.

The rotation of the spool 18 is thereby transmitted to the flywheel 74 of the second FL mechanism 44, such that the inertial force of the flywheel 74 acts on the spool 18 in cases in which the rotation of the spool 18 is speeding up or decelerating. The present exemplary embodiment is thus capable of obtaining similar advantageous effects to those of the first exemplary embodiment.

Note that each of the exemplary embodiments described above is configured with a planetary gear train in which, when rotational force of the spool 18 is input to the carrier plate 52 in a state in which rotation of the gear plate 66, configured by an internal gear, is restricted, the rotational force of the spool 18 is output to the sun gear 78 of the flywheel 74, serving as an inertial body, through the planetary gears 58. However, configuration may be made in which a planetary gear train, configured such that rotational force of the spool 18 input to a sun gear or an internal gear in a state in which rotation of the carrier plate or the sun gear is restricted is output from a carrier plate or an internal gear, is provided between the spool 18 and an inertial body.

In each of the exemplary embodiments described above, the retention of the restricting pawl 82 or the slider 144 by the rod 102 of the trigger device 100 is mechanically coordinated with the pre-tensioner 28, enabling the restricting pawl 82 or the slider 144 to be actuated by the pre-tensioner 28. However, for example, configuration may be made in which a drive section such as a motor or a solenoid is driven based on an electrical signal output from a control device that actuates the pre-tensioner 28, such that a restricting member is actuated, or a restricting member is capable of being actuated, by drive force of the drive section. There is no particular limitation to the configuration by which actuation of the restricting member or the ability to actuate of the restricting member is coordinated with actuation of the pre-tensioner.

The disclosure of Japanese Patent Application No. 2016-66067, filed on Mar. 29, 2016, is incorporated in its entirety by reference herein.

1. A webbing take-up device comprising:
a spool that is rotated in a take-up direction to take up a webbing;
a pre-tensioner that is actuated in a vehicle emergency to rotate the spool in the take-up direction;
an inertial body to which rotation of the spool is transmitted so as to impart an inertial force to the spool according to a rotational acceleration of the spool or according to a magnitude of a rotation speed of the spool; and
a clutch mechanism that suppresses transmission of take-up direction rotation from the spool to the inertial body, and that transmits inertial force of the inertial body in the take-up direction or in a pull-out direction of the spool to the spool when the spool rotates in the pull-out direction following actuation of the pre-tensioner.

2. The webbing take-up device of claim 1, wherein the clutch mechanism includes:
a moving member that is moved by rotation of the spool such that rotation is suppressed from being transmitted from the spool to the inertial body, and that by being restricted from moving results in rotation from the spool being transmitted to the inertial body; and
a restricting member that is capable of engaging with the moving member, and that restricts movement of the moving member by engaging with the moving member when the spool rotates in the pull-out direction following actuation of the pre-tensioner.

3. The webbing take-up device of claim 2, wherein the restricting member enables the moving member to be moved by take-up direction rotation of the spool in a state in which the restricting member is engaged with the moving member, and restricts the moving member from being moved by both pull-out direction rotation of the spool and take-up direction rotation of the spool when, in a state in which the restricting member is engaged with the moving member, the restricting member has been moved together with the moving member by a predetermined amount as a result of pull-out direction rotation of the spool.

4. The webbing take-up device of claim 3, further comprising a retention member that is moved by the restricting member being moved together with the moving member by a predetermined amount as a result of pull-out direction rotation of the spool in a state in which the restricting member is engaged with the moving member, and that engages with the restricting member so as to retain the engagement between the restricting member and the moving member.

5. The webbing take-up device of claim 2, further comprising a blocking member that blocks engagement of the restricting member with the moving member, and that releases the blocking of engagement of the restricting member with the moving member accompanying pull-out direction rotation of the spool.

6. The webbing take-up device of claim 1, further comprising a trigger section that retains the clutch mechanism in a state in which take-up direction rotation is suppressed from being transmitted from the spool to the inertial body, and that releases the retention of the clutch mechanism when actuated mechanically in coordination with actuation of the pre-tensioner.
